(19) United States
(12) Patent Application Publication
(10) Pub. No.: US 2012/0251305 A1
(43) Pub. Date: Oct. 4, 2012

(54) IMPACTOR CONTAINMENT

(75) Inventor: Alison J. McMILLAN, Uttoxeter (GB)

(73) Assignee: ROLLS-ROYCE PLC, London (GB)

(21) Appl. No.: 13/418,876

(22) Filed: Mar. 13, 2012

(30) Foreign Application Priority Data
Mar. 29, 2011 (GB) 1105185.1

(51) Int. Cl. F04D 29/42; B23P 15/00

(52) U.S. Cl. 415/182.1; 29/888.02

(57) ABSTRACT

A containment system 20 is described, e.g. for a gas turbine engine. The system 20 includes a containment casing 22 and may also include a face sheet 30 and a backing layer 32. The casing 22 includes a matrix material 24 and regions 26 formed of a second material different to the matrix material. Fibres 28 are also included, formed of a third material.

The present invention relates to impactor containment, and particularly to impactor containment casings for rotating components, and methods of manufacturing such containment casings.

Gas turbine engines conventionally comprise rotating components, including turbine blades and fan blades. Such rotating components are generally housed inside a casing, which includes a containment system designed to absorb energy from impactors.

As used herein the term ‘impactor’ means an item impacting on the containment system, generally from an interior of the containment system. Such an impactor might for example be a piece of a turbine blade, or a turbine blade itself. An impactor might alternatively include a piece of debris which has been drawn inside the casing by the turbine, such as ice or a bird.

In the event of such an impactor strike to the casing, it is desirable that the casing absorbs as much kinetic energy as possible from the impactor, as it is undesirable for an impactor to penetrate the casing with high enough energy to hazard the aircraft.

Typically a gas turbine containment system comprises a casing formed from a solid ductile material such as a metal. Such casings can be effective at containing impactors, but are typically heavy due to the thickness of material required to be effective.

According to a first aspect of the present invention there is provided an impactor containment casing for housing rotating components, comprising a matrix material and at least one region formed of a second material different to the matrix material, and fibres formed of a third material.

A conventional metal containment system absorbs energy from an impactor mainly through deformation of the metal under the impact. This deformation is comprised of elastic and plastic strain, and possibly small fractures. The elastic energy absorbed is relatively small, and it is released as vibration, which is usually damped by friction at the interfaces with other components, material viscoelasticity, vibration amplitude sufficiently high to involve non-linear effects, or by other damage effects. The energy absorbing capacity of solid metals through plasticity is limited to the volume of material undergoing the plastic strain, and the strain to failure characteristic of the material. Even high ductility metals are inefficient at absorbing high speed impact energy, because the impact duration is too short for the stress to propagate far within the structure, so only a small region of material is involved in the plastic strain. Energy absorbed though fracture would be limited as this is proportional to the exposed surface area of the crack surface. If high energy fragments of the impactor are to be contained, the cracks must remain small.

In contrast, a containment casing of the type described above absorbs energy through a variety of different mechanisms. The present containment casing has the effect of extending the impact duration by allowing more travel of the impactor during the impact. This means that more material of the containment casing can be involved in absorbing the kinetic energy. To allow more travel, the velocity direction may be better redirected rather than opposed directly. This is achieved in the present containment casing through arrangement of a structure having regions of different stiffness. Energy absorption can be spread to more material and the mechanisms of plasticity and failure can be harnessed more effectively. For example crush of material implies plastic deformation, which can be invoked multiple times, as the material is crushed in one direction, and perhaps again in another. Failure of multiple small sub-structures can absorb large amounts of energy. In both cases, even if there is substantial localised damage, the overall structure would remain largely intact, and capable of fulfilling its normal mechanical duties.

Because the containment casing includes a region of a different material to the matrix material, in the event of an impact one of those materials will collapse preferentially over the other. This spreads the impact energy over a wider area of the containment casing than if the casing were formed of a single material. Furthermore, in the event of an impact the fibres stretch and deform as the impactor travels within the containment casing, absorbing energy from the impactor. Further energy is lost as the fibres are pulled through or out of the matrix material by the impactor.

The matrix material may encase the second material and the fibres. The matrix material may comprise a metallic material, or a non-metallic material, and may comprise an organic matrix such as a resin. The matrix material may comprise a ceramic material.

The regions of second material may be collapsible, and may be formed of a material having a lower rigidity than the matrix material. The second material may comprise a non-metallic material, and may comprise a foam body. The second material may comprise a void or hollow within the matrix material. The void may comprise a fluid, which may be a compressible fluid such as a gas, or may be an incompressible fluid such as a liquid.

The containment casing may comprise a plurality of regions of second material. The regions may be discrete regions, for example, discrete tubular regions extending through the matrix material. The containment casing may comprise one or more network-like or branching regions.

The fibres may be reinforcing fibres, and may be substantially continuous. The fibres may include one or more of carbon fibres, glass fibres, aramid fibres, basalt fibres, metallic wires or hybrid tows of multiple filaments of a single material or of mixed materials. Alternatively or additionally, other reinforcing fibres might be used, such as shape memory alloy (SMA) wires, or fibres sold under the trade names Dyneema and Kevlar.

There may be a plurality of fibres. The fibres may cross so as to form a net-like reinforcing structure. The fibres may be impregnated with the first material

The fibres may be comprised in a woven fabric, which may comprise a 3D woven fabric. The woven fabric may further comprise the second material.

The containment casing may be comprised within a containment system for a gas turbine or a portion of a gas turbine. The containment casing may be shaped so as to extend around the gas turbine/gas turbine portion. The containment casing may be substantially circular in cross section, and may, for example be substantially cylindrical or conical.

The containment casing may further comprise a backing layer providing a first surface of the containment casing, and may comprise a facing layer providing a second, possibly opposed, surface of the containment casing. The backing layer may be disposed on an exterior surface of the containment casing. The backing layer may be stiffer than the combined matrix and second materials, and may comprise a metal.

According to a second aspect of the invention there is provided a gas turbine engine comprising an impactor containment casing as described in relation to the first aspect of the invention.

According to a third aspect of the invention there is provided a preform fabric for use in manufacturing an impactor containment casing, the fabric comprising a plurality of substantially continuous reinforcing fibres and at least one former.

The former may comprise an insert operable to define a region of a second material in the containment system. The former may comprise a foaming agent, such that the former can be caused to expand in volume. The former may comprise a tape including a foaming agent. An example of a suitable foaming agent is sold under the trade name Expancel. The former may comprise a removable insert.

The fabric may comprise a 3D woven fabric. It may comprise a 2D woven or 2D laminated fabric, which may or may not be held together in the through-thickness direction by stitching, tufting or mechanical fixings, such as Z pins.

According to a fourth aspect of the invention there is provided a method of manufacturing an impactor containment casing comprising a matrix material and at least one region formed of a second material different to the matrix material, and fibres formed of a third material, the method including disposing the fibres and at least one former for the region within the matrix material.

The former may be operable to expand to form the region of second material. The method may comprise the step of causing the former to expand, for example by applying heat to the former. The former may comprise a tool, and the method may comprise removing the tool from the matrix material to form the region of second material.

The method may comprise disposing the fibres and the former in a predetermined orientation. The matrix material may comprise a settable material, and the method may comprise encasing the fibres and the former in the settable matrix, and allowing and/or causing the settable matrix to set, for example by curing or solidification. The fibres may be impregnated with matrix material.

The method may comprise winding the fibres and, possibly, the former around a mandrel. The fibres may be impregnated with matrix material prior to, during or after winding.

The method may comprise weaving the fibres and, possibly, the former, into a fabric. The method may comprise positioning the fabric in a predetermined orientation, for example wrapping the fabric around a mandrel, or lining a mould with the fabric. The fabric may be impregnated with matrix material prior to, during or after positioning. The fabric may be wrapped twice around the mandrel, so as to form a double thickness of fabric.

The present invention will now be described, by way of example only, with reference to the accompanying drawings, in which:

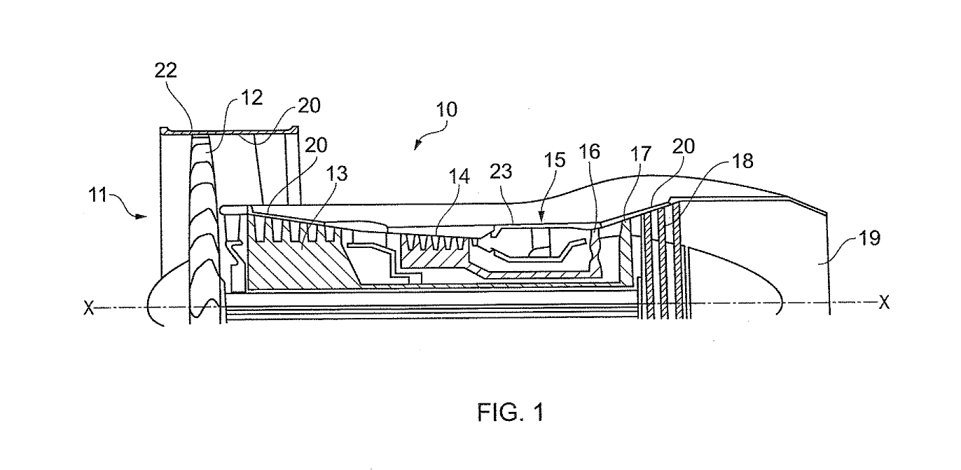

FIG. 1 shows a schematic cross-sectional view of a gas turbine engine;

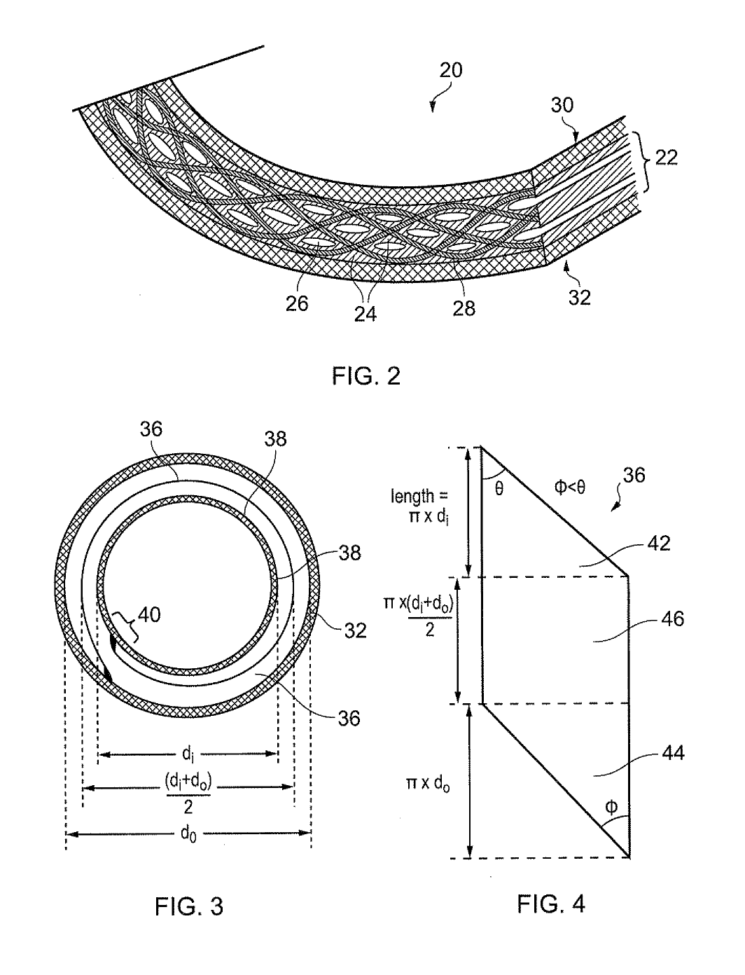

FIG. 2 is a sectional view through a segment of a containment casing;

FIG. 3 shows a cross section through a containment casing;

FIG. 4 shows a plan view of a fabric for use in the containment casing of FIG. 3;

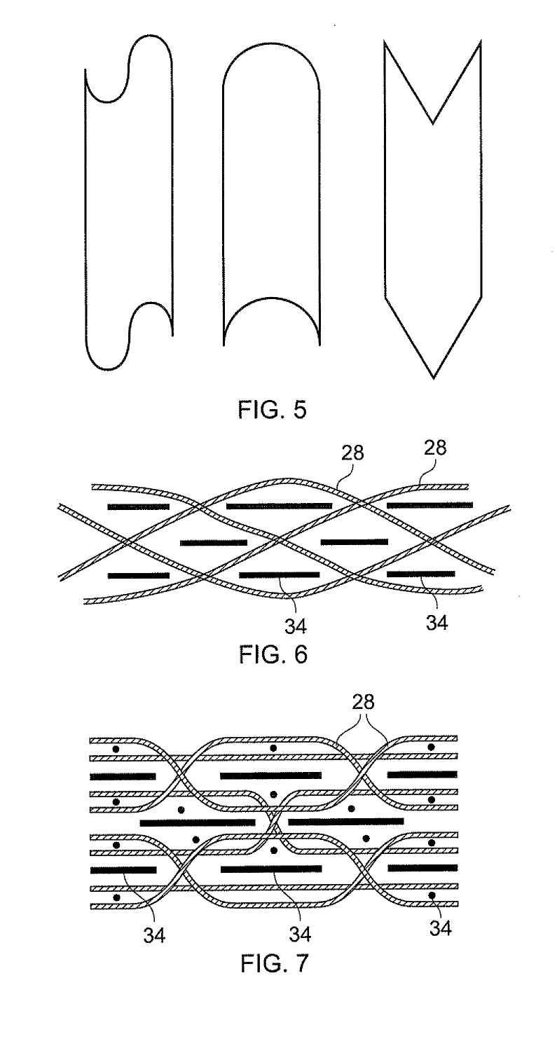

FIG. 5 shows a selection of alternative fabric shapes;

FIG. 6 shows a cross section through a portion of a woven fabric;

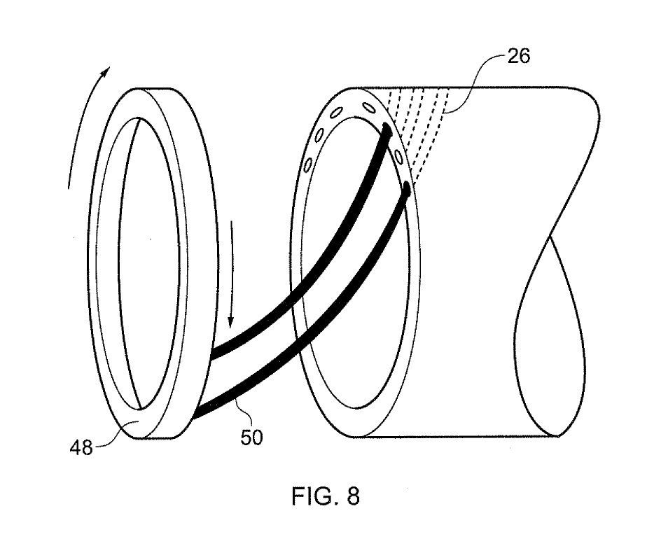

FIG. 7 shows a cross section through a portion of an alternative woven fabric; and

FIG. 8 illustrates an alternative production method.

Referring to FIG. 1, a gas turbine engine is generally indicated at 10 and comprises, in axial flow series in its gas path, an air intake 11, a propulsive fan 12, an intermediate pressure compressor 13, a high pressure compressor 14, a combustor 15, a turbine arrangement comprising a high pressure turbine 16, and intermediate pressure turbine 17 and a low pressure turbine 18, and an exhaust nozzle 19.

The gas turbine engine 10 for an aircraft operates in a conventional manner so that air entering the intake 11 is accelerated by the fan 12 which produces two air flows: a first air flow into the intermediate pressure compressor 13 and a second air flow which provides propulsive thrust. The intermediate pressure compressor 13 compresses the air flow directed into it before delivering that air to the high pressure compressor 14 where further compression takes place.

The compressed air exhausted from the high pressure compressor 14 is directed into the combustor 15 where it is mixed with fuel and the mixture combusted. The resultant hot combustion products then expand through, and thereby drive, the high, intermediate and low pressure turbines 16, 17 and 18 before being exhausted through the nozzle 19 to provide additional propulsive thrust. The high, intermediate and low pressure turbines 16, 17 and 18 respectively drive the high and intermediate pressure compressors 14 and 13 and the fan 12 by suitable interconnecting shafts. The fan 12, the compressors 13, 14 and the turbines 16, 17, 18 are surrounded by containment systems designated generally by the numeral 20. A containment system 20 is generally cylindrical, or frusto-conical, and is arranged substantially coaxially around the fan 12, the compressors 13, 14 or the turbines 16, 17 and 18.

It is a certification requirement of gas turbine engines that, should components such as fan blades, compressor blades, turbine blades or pieces thereof become detached from other parts of the assemblies, these pieces must be contained. Should this happen, the high energy of the blade or blade piece would cause it to strike the inside of the containment system 20 of the gas turbine engine 10.

It is thus necessary to ensure that the kinetic energy of the blades is absorbed by the containment system 20. The containment system 20 around the fan 12 includes a containment casing 22. The full containment system 20 will usually include other elements, in addition to the casing 22. These other elements do not themselves form part of the present invention and are therefore not described further. Other parts of the engine, e.g. compressor, turbine etc. may have similar containment casings (not shown in FIG. 1).

A cross section through the containment casing 22 of the containment system 20 is shown in FIG. 2, which allows the structure of the containment casing 22 to be seen.

The containment casing 22 includes a matrix material 24, in at least one region, and in this case a plurality of regions, 26 formed of a second material different to the first, and a plurality of fibres 28 formed of a third material. In the example shown the matrix material surrounds and substantially completely encases the regions 26 and fibres 28. The containment casing is generally cylindrical, and is shaped and sized to enclose the fan 12.

In the example shown in FIG. 2, the matrix material 24 may be a non-metallic material such as an organic matrix, and in particular may be an epoxy resin. The regions 26 may also be non-metallic, solid or fluid, or substantially hollow (i.e. gas/air-filled). The fibres are reinforcing fibres. Example materials for the reinforcing fibres include carbon fibre, basalt fibre, metallic wires, hybrid tows of multiple filaments of a single or mixed materials, glass fibres, aramid fibres, SMA (shape memory alloy) wires, or materials sold under the trade names Dyneema and Kevlar.

The containment casing thus comprises a composite structure, rather than a metallic one. Composite structures are generally lighter than metallic structures, but have heretofore been thought of as unsuitable for use as a containment system, as organic matrices such as resin are generally more brittle than their metallic counterparts, and are thus less able to absorb impact energy through plastic strain. We have found however that the combination of the three distinct material components (matrix material, second material regions and third material fibres) results in an effective containment system.

In particular, the regions 26 are crushable. The regions 26 are thus regions of weakness which collapse preferentially in the event of an impactor impact. The collapse of the regions 26 deforms or fractures and cracks the matrix material around the regions, absorbing energy from the impactor.

At the same time, the fibres 28 stretch as the impactor travels into the casing. Fibres such as carbon have a high elastic stiffness under tension, and kinetic energy is absorbed from the impactor as elastic potential energy as the fibres stretch. Subsequent motion of the impactor, and vibration within the fibres, ultimately pulls the fibres from the matrix material, causing the elastic energy to be shed in friction and as fracture energy.

Thus in the event of an impact, elements of the containment casing are able to collapse and/or fracture. The fractures propagate to absorb energy from the impactor, and spread the force of the impact over a wide area. The fibres act as a net which catches the impactor, as well as absorbing further energy from the impactor through fibre pull-out, material deformation and friction. The containment casing is able to contain the impactor with its structure largely intact. The containment casing remains operational as a stiff ring, and continues to do so until the plane flies to a safe landing place, in accordance with airworthiness requirements.

The portion of containment casing shown in FIG. 2 also includes a face sheet 30 on the inner surface of the casing (that is the surface which is facing the housed rotating component, and which would be the first surface to experience the impact). The face sheet may comprise a composite, or may comprise a metal such as a titanium alloy. The containment casing also includes a backing layer 32, which again might be metallic. The backing layer may be stiffer than the other layers.

Thus, the matrix material 24, the second material 26 and the fibres 28 together form an intermediate layer between the face sheet 30 and the backing layer 32.

The face sheet is thin (e.g. less than 5 mm, such as 0.25-3 mm, thick) and aims to deflect an impactor such that it travels through the containment casing at an angle to a radius, so that the impactor travels a greater distance through the casing before impacting the backing layer. The face sheet prevents premature penetration, and spreads the load of the impactor into the containment casing. The intermediate layer of the matrix material 24, second material 26 and fibres 28 crushes while the face sheet 30 stretches. The impactor velocity is angled to start with, so that direction sees more crush, and thus the impactor velocity angle is increased (i.e. deflected more away from the normal to the surface).

The containment casing 22 shown in FIG. 2 includes a plurality of collapsible regions 26 at a plurality of different radial depths. The regions are, in this example, discrete, tubular and extend generally axially.

The containment casing 22 also includes a plurality of fibres 28, again at a plurality of different radial depths. The fibres extend generally circumferentially through the containment casing. The fibres cross multiple times so as to create a net-like or woven structure within the matrix material from which the containment casing is formed.

The intermediate layer of the containment casing can be formed by any suitable method. One such method of manufacture comprises three dimensional (3D) weaving, and that will now be discussed with relation to FIGS. 3 to 7.

In the 3D weaving method, a preform fabric is first produced using fibres and a former for the regions of second material. The formers used depend on the desired structure for the regions. For example, the formers might comprise shaped second material, for example shaped foam, and may themselves constitute the regions of second material. Alternatively, the formers may comprise an insert shaped to define a volume which, when the insert is removed, will result in hollow regions, which can then be filled with a selected second material if desired. Such an insert might comprise an inflatable insert such as a balloon which can be deflated or popped, or a rigid insert, which can subsequently be withdrawn. Another former option is that the formers might comprise a foaming agent, which can be caused to expand in specific circumstances (e.g. on the application of heat, or the addition of a particular chemical). The formers can thus be placed in the desired location of the regions, and caused to expand to form the regions. The former may comprise a tape including a foaming agent. An example of a suitable foaming agent is sold under the trade name Expancel.

The shape, size and number of formers depend on the desired distribution of regions of second material within the containment system. The regions might be elongate, for example longitudinal, helical and/or serpentine (i.e. weaving back and forth). The regions might be branching or network-like. Alternatively, the regions might be generally spheroid in shape.

The actual shape and number of regions is not critical. However, it is desirable that the regions make up a significant portion of the volume of the containment structure when it is complete. For example, the regions should make up between 10 and 90% of the volume, and in particular around 25 to 65% of the volume. In an example structure, the matrix material makes up approximately 35% of the intermediate layer of the containment casing, the fibres also make up substantially 35% and the regions of second material make up substantially 30% by volume.

Various weave structures are possible, depending on the ratio of fibres to formers required, the depth of fabric required and the required pattern of second regions in the finished containment system. Two examples of weave structures are shown in FIGS. 6 and 7.

In FIG. 6 formers 34 are arranged in a three dimensional pattern according to the required distribution of the regions. In this case, the formers comprise foam tapes and are arranged in three layers, with the middle layer being offset between the two outer layers. Transverse fibres are woven diagonally between the formers, such that each fibre extends around an upper layer former, over a second layer former and around a bottom layer former, and so on, to form the fabric. FIG. 6 shows a cross section through a portion of the resulting fabric. The formers extend longitudinally into the plane of the page.

An alternative weave structure is shown in FIG. 7. Again, formers 34 are arranged in a three dimensional pattern, in three layers as before. Pairs of fibres 28 are woven in and out of the formers in each layer, and through the fibres weaving around adjacent layers. Further fibres 29 weave longitudinally through the fabric.

The resultant woven fabric is a flat preform 36 of the sort shown in FIG. 4. The preform 36 can be rolled into a tube (for example around a mandrel, or within a mould), and subsequently encased and/or impregnated with the first material to form the containment structure. In FIG. 3 the preform 36 is rolled twice around an inner tubular member 38 which forms the face sheet 30.

The fabric is rolled in multiple layers (shown as a double layer), to provide additional strength. The ends of the fabric are arranged to overlap slightly in an overlap region 40. The preform 36 is shaped so that the join line is distributed around the circumference of the roll, to avoid creating a longitudinal line of weakness.

The preform 36 shown in FIG. 4 is a quadrilateral which is generally near rhomboid in shape. Many other preform shapes are possible, some of which are illustrated in FIG. 5. In all preform shapes it is necessary to allow for the fact that the preform has some depth. Thus the preform needs to be shaped to take into account the fact that there will be a difference in circumference between the inner winding and the outer winding (assuming the preform is to be wound in multiple layers).

As shown in FIGS. 3 and 4, in the case of a substantially rhomboid preform, this can be achieved be ensuring that a first angled portion 42 of the preform has a length that is equal to the inner circumference (πdᵢ), and a second angled portion 44 has a length that is equal to the outer circumference (πdₒ). A rectangular portion 46 extending between the two angled portions has a length equal to an average circumference (π(dᵢ+dₒ)/2). The preform is not a true rhombus, as the angle of inclination of the first portion 42 (θ) is greater than the angle of inclination of the second portion 44 (φ). Such a preform can be rolled starting from the first angled portion 42 to form a cylindrical tube of substantially constant circumference.

After rolling, the preform is then impregnated with matrix material. Where the formers comprise a foaming agent tape 34, the formers are caused to expand to define the regions of second material. An outer layer 32 is applied over the preform, and the containment intermediate layer is then allowed to set/cure.

We have found woven fabrics of the type described above to be useful in constructing a containment casing, as such fabrics provide an additional mechanism for energy absorption. The fibres are twisted in and out of formers in creating the fabric, and additional energy can be absorbed from an impactor in uncoiling the fibres, as well as in stretching the fibres. However, a containment casing can be formed in other ways to that described above, if preferred. For example, the fibres and regions of second material might be placed and/or defined in a filament winding process.

In such a process, the formers might comprise a tool 48 of the type shown in FIG. 8. The tool includes a plurality of inserts 50 arranged to define second regions in the form of holes or voids. Fibre filaments (possibly impregnated with matrix material) can be wound around the tool. The filaments might be wound clockwise, anticlockwise, or both. The filaments might be wound at a constant winding angle (with respect to the longitudinal axis of the structure), or at a variety of different winding angles, as desired.

A containment casing made by a 3D filament winding process can be made as a complete cylinder with no split lines. The filaments might be wound so as to form as structure similar in cross section to the 3D woven structures shown in FIGS. 6 and 7, for example, using a braiding machine. The inserts (foaming tape, balloons, etc) which form the regions 26 would need to be quite flexible in this case, as they would need to be pulled back to allow the filament to be wound under and over them. Alternatively, the position of the regions could be marked by temporary rods, which would be rigid, and either straight or formed in a helix and can individually be extended or retracted, so that the filament covers them or misses them, depending on requirements at each wind. A beat-up mechanism might compact the weave. For example, a cylindrical set of segments which operate in sequence might follow the filament winding head as it goes around the cylinder.

A containment casing of the type described herein can be lighter than an equivalent metallic containment structure. Energy is absorbed from an impactor via a variety of different methods, making a composite structure of the type described more efficient at containing impactors than a composite structure made from a matrix material, even if that structure includes reinforcing. As discussed above, the containment casing need not be a fully composite structure, and may include metallic components. Such a composite/metallic structure might be termed a hybrid structure.

The containment casing described herein may be used to contain impactors detached from a metal turbine, including a metal turbine blade, as well as containing an impactor detached from a composite turbine.

Various modifications may be made without departing from the scope of the invention.

For example, the regions of second material might be formed in the matrix material by any suitable means, and not necessarily by the 3D weaving or filament winding processes described above. Two dimensional (2D) woven or laminated fabric may be used. They may be held together in the through-thickness direction by stitching, tufting or mechanical fixings, such as Z pins.

The matrix material might be any suitable material including, but not limited to, an organic matrix such as a resin, a ceramic matrix, or a metallic matrix such titanium, aluminium, etc.

The fibres might be any suitable reinforcing fibre such as glass, carbon, aramid, basalt, Kevlar, Dyneema, SMA or a combination of such fibres, or metallic wires.

The containment system need not comprise either or both of the face sheet and backing layer. If present, the backing layer might comprise reinforcing, such as reinforcing ribs, which may be metallic.

The containment casing might be any shape, depending on the type of rotating components to be contained with the structure.

1. An impactor containment casing for housing rotating components, comprising a matrix material and at least one region formed of a second material different to the matrix material, and fibres formed of a third material.

2. The containment casing of claim 1, wherein the regions of second material are formed of a material having a lower rigidity than the matrix material.

3. The containment casing of claim 1, wherein the matrix material encases the second material and the fibres.

4. The containment casing of claim 1, wherein the second material comprises a void within the first material.

5. The containment casing of claim 4, wherein the void is filled with a fluid.

6. The containment casing of claim 1, wherein the containment casing comprises a plurality of regions of second material.

7. The containment casing of claim 1, wherein the fibres cross so as to form a net-like reinforcing structure.

8. The containment casing of claim 1, wherein the fibres are comprised in a woven fabric.

9. The containment casing of claim 8, wherein the woven fabric further comprises the regions of second material.

10. The containment casing of claim 1 further comprising a backing layer on a first surface of the containment casing.

11. The containment casing of claim 10 wherein the backing layer is stiffer than the layer provided by the matrix, second material and fibres.

12. The containment casing of claim 1, further comprising a facing layer on a second surface.

13. A preform fabric for use in manufacturing an impactor containment casing, the fabric comprising a plurality of substantially continuous reinforcing fibres and at least one former.

14. The preform fabric of claim 13, wherein the former comprises an insert arranged to define a region of second material.

15. The preform fabric of claim 13, wherein the former comprises a foaming agent, such that the former can be caused to expand in volume.

16. The preform fabric of claim 13 wherein the fabric comprises a 3D woven fabric.

17. A method of manufacturing an impactor containment casing comprising a matrix material and at least one region formed of a second material different to the matrix material, and fibres formed of a third material, the method including disposing the fibres and at least one former for the region within the matrix material.

18. The method of claim 17 wherein the former is operable to expand to form the region of second material.

19. The method of claim 17 wherein the former comprises a tool, and the method comprises removing the tool from the matrix material to form the region of second material.
